(19) United States
(12) Patent Application Publication
(10) Pub. No.: US 2004/0063086 A1
(43) Pub. Date: Apr. 1, 2004

(54) Interactive learning computer system

(75) Inventors: Kuo-Ping Yang, Taipei (TW); Ching-Hsiang Shih, Taipei (TW); Yen-Jui Chiao, Taipei (TW); Chi-Lai Chen, Taipei (TW); Shu-Hua Guo, Taipei (TW)

Correspondence Address: BACON & THOMAS, PLLC, 625 SLATERS LANE, FOURTH FLOOR, ALEXANDRIA, VA, 22314

(73) Assignee: Kuo-Ping Yang,, Taipei (TW)

(21) Appl. No.: 10/656,367

(22) Filed: Sep. 8, 2003

(30) Foreign Application Priority Data
Sep. 30, 2002 (TW) 091122559

(51) Int. Cl. G09B 3/00

(52) U.S. Cl. 434/350

(57) ABSTRACT

An interactive learning software program includes a teaching computer, a plurality of operational devices and a notebook computer. The teaching computer is used for executing at least one interactive learning software program. The plurality of operational devices are used by the plurality of students and output an operational instruction to the teaching computer to use the interactive learning system. The notebook computer is used by the teacher, and the notebook computer is capable of executing an interactive control software program to output a control instruction to the teaching computer so that the interactive learning software selectively accepts the operating instruction from the operational device.

### BACKGROUND OF THE INVENTION

1. Field of the Invention

The present invention relates to an interactive learning computer system and, more particularly, to a learning environment for a school.

2. Description of Related Art

Due to the increasing popularity of computers, the development of computer aided teaching is becoming more and more important. In the majority of teaching environments, a teacher operates a computer to teach a plurality of students. In some computer classrooms, every student or every pair of students, uses one computer to practice by themselves. However, these prior art teaching methods are somewhat inconvenient.

For example, in the first environment that provides one computer in a classroom, when the teacher wishes to call upon a student to answer a question, he or she may do so orally, and the assigned student can respond orally. But if the question is related to some operations on the computer, the student will have to leave his or her seat in order to operate the computer.

When every student or every pair of students has one computer to use, although the called-upon student doesn't need to leave his or her seat to answer a question, it is possible that other students can help him or her cheat. The teacher can install additional software to prevent this from occurring, but this requires the resetting of the teaching computer. Furthermore, it is quite expensive to provide a plurality of computers in the regular classroom environment, and so a school can usually afford to provide only one or two computer classrooms.

It is therefore an objective of this invention to provide an interactive program that can be used in a regular classroom at a lower cost.

### SUMMARY OF THE INVENTION

A main objective of the present invention is to provide a simple interactive learning system which can provide a very cheap and flexible interactive teaching environment.

Another objective of the present invention is to provide an interactive learning system which easily enables a teacher to change his or her teaching style for improved learning effects.

Another objective of the present invention is to provide an interactive learning software program with an operation instruction status list that enables the interactive learning software program to be easily and flexibly controlled.

In order to achieve the above mentioned objectives, the interactive learning system of the present invention is used in a computer teaching environment having a teacher with a plurality of students. The interactive learning system has:

a teaching computer for executing at least one interactive learning software program;

a plurality of operational devices for use by the plurality of students and outputting an operational instruction to the teaching computer to use the interactive learning system; and

a notebook computer for use by the teacher, the notebook computer capable of executing an interactive control software program to output a control instruction to the teaching computer so that the interactive learning software selectively accepts the operating instruction from the operational device. In an embodiment, there are three different interactive manner options, which include “assigned”, “random” and “competitive”. The teacher can use the portable computer to specify the interactive manner for the interactive learning program, and a control instruction of the interactive manner is sent to the teaching computer to set up the operation instruction status list.

The teacher can use the interactive control software program to specify each operational device to process the operational instruction so that the interactive learning software selectively accepts the operating instruction according to a specification provided by the teacher.

Other objectives, advantages, and novel features of the invention will become more apparent from the following detailed description when taken in conjunction with the accompanying drawings.

### BRIEF DESCRIPTION OF THE DRAWINGS

FIG. 1 is a drawing of an interactive learning environment according to the first invention.

FIG. 2 is a schematic drawing of an operational device according to the present invention.

FIG. 3 is a circuit drawing of the operational device of FIG. 2 according to the present invention.

FIG. 4 is a circuit drawing of a portable computer according to the present invention.

FIG. 5 is a circuit drawing of a connection device according to the present invention.

FIG. 6 is a flowchart of a interactive learning system according to the present invention.

FIG. 7 shows an embodiment of an operational instruction status list according to the present invention.

FIG. 8 shows an operating screen of the portable computer of FIG. 4 according to present invention.

FIG. 9 shows another operating screen of the portable computer of FIG. 4 according to present invention.

### DETAILED DESCRIPTION OF THE PREFERRED EMBODIMENT

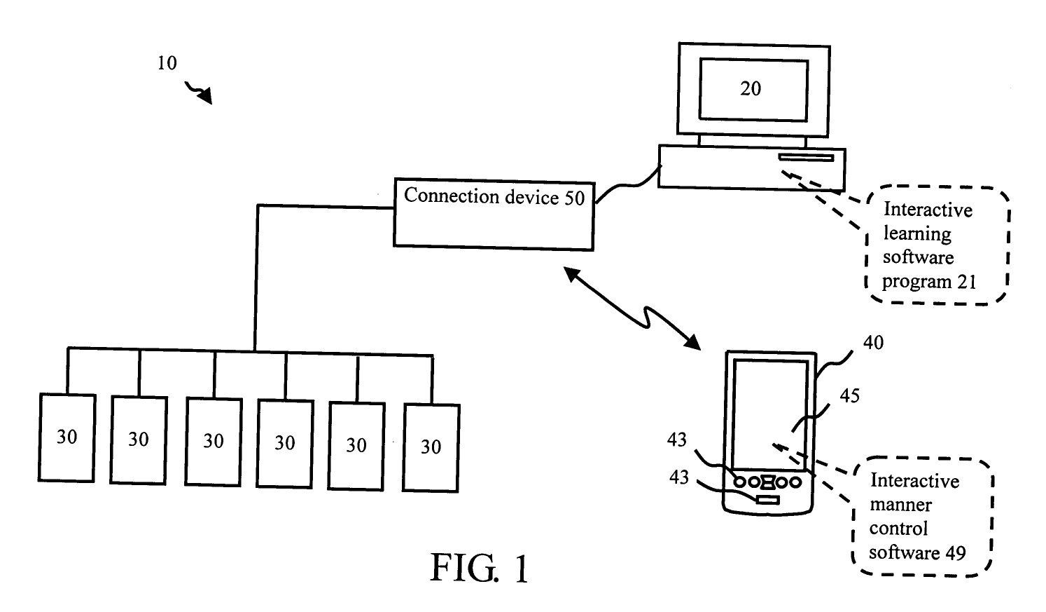

Please refer to FIG. 1. FIG. 1 is a drawing of an interactive learning environment according to a first embodiment of the present invention. In the present invention, an interactive learning system 10 can be applied in a computer environment for a teacher and a plurality of students.

A teaching computer 20 can be a typical computer. The teaching computer 20 is used to execute at least one interactive learning program 21. The interactive learning program 21 is simple quiz learning software, or complex quiz learning software. The teaching computer 20 outputs pictures for the teacher and the plurality of students. The output pictures can also be sent to a projector.

Each student uses an operational device 30 to serve as an input tool for the teaching computer 20, which output a plurality of operational instructions to the teaching computer 20 to control the interactive learning program 21. It is a preferred method that every student has one operational device, but it is also acceptable if several students share one operational device 30.

The teacher operates a portable computer 40, and the portable computer 40 can be a personal digital assistant (PDA). In the prior art system, the teacher operates the teaching computer 20 directly, but in the present invention, the teacher can move around with the portable computer 40 and use the portable computer 40 to control the teaching computer 20. However, the main characteristic of the present invention is that the teacher can use interactive manner control software 49 installed in the portable computer 40. The following description explains a flowchart of the present invention.

There is a connection device 50 in this embodiment. The connection device 50 is connected to the operational device 30 and the teaching computer 20 via cables, so that the operational instruction output by the operational device 30 can be received by the teaching computer 20. Furthermore, signals from the portable computer 40 are sent to the connection device 50 and then to the teaching computer 20. In this embodiment, the portable computer 40 is wirelessly connected to the connection device 50. It should be clear that any apparatus in the interactive learning system 10 can be connected with cables, or in a wireless manner. An additional item that should be noted is that if the teaching computer is an advanced model or supports a suitable design, the connection device 50 may be not necessary. For example, if the teaching computer 20 supports wireless communications, the portable computer 40 can communicate with the teaching computer 20 directly.

The following description relates to the hardware structure of the operational device 30, the portable computer 40 and the connection device 50. Since the teaching computer 20 is a regular computer, no additional explanation in this regard is required.

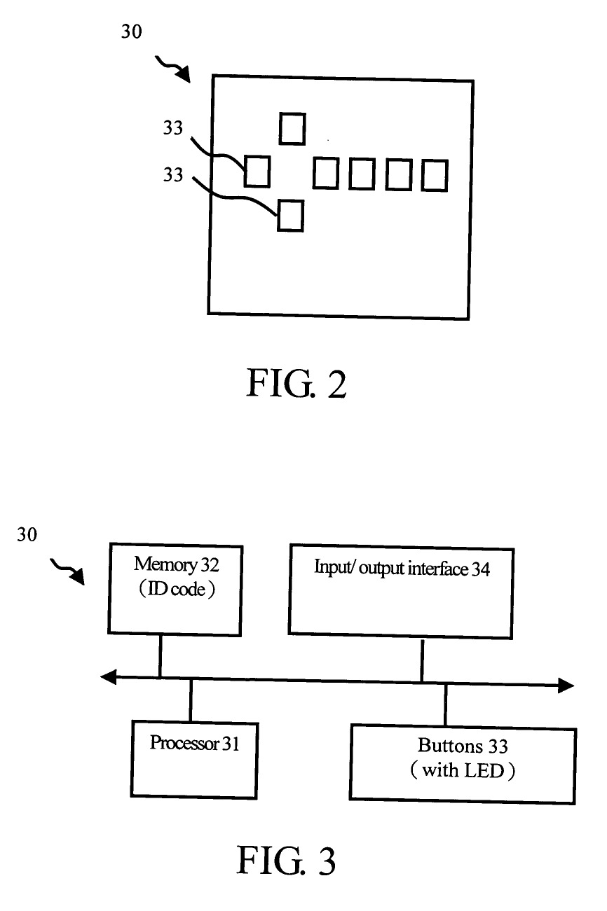

FIG. 2 is a schematic drawing of an operational device 30 according to the present invention. The operational device 30 can be box shaped with a plurality of buttons 33. These buttons 33 may be up, down, left and right buttons, 1, 2, 3, 4 buttons, or the like. Moreover, the operational device 30 can also have a touch screen (similar to a PDA), and in this case the plurality of buttons 33 may be visual buttons on the screen.

FIG. 3 is a circuit drawing of the operational device 30 according to the present invention. The operational device 30 comprises a processor 31, a memory 32, the plurality of buttons 33 and an input/output interface 34 which is used to connect the connection device 50. In fact, the operational device 30 is a common electrical input device (e.g. similar to an external keyboard), but which is not the point of the present invention and so is not elaborated upon.

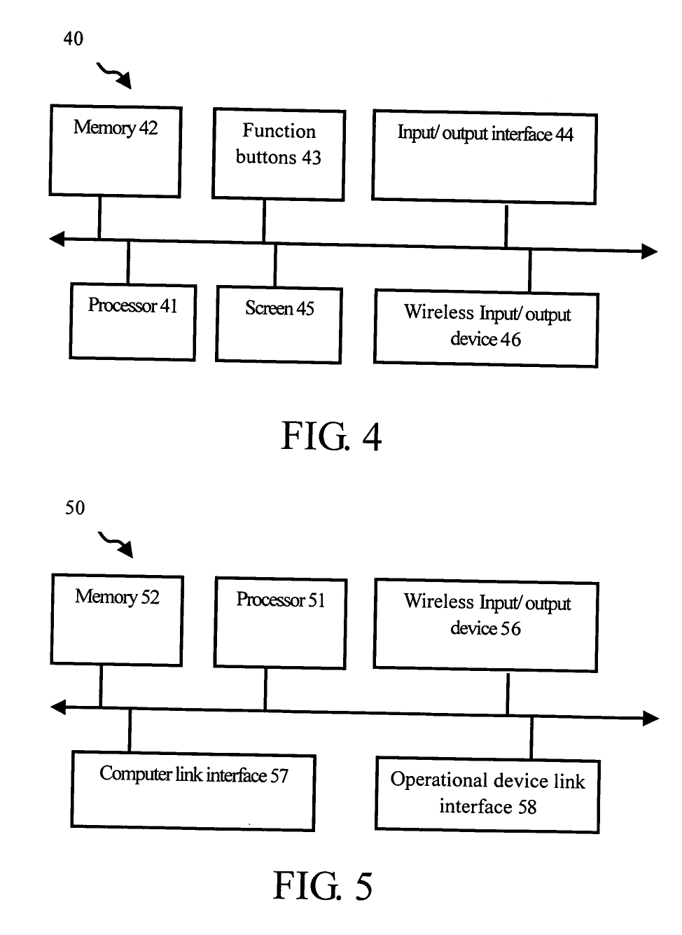

FIG. 4 is a circuit drawing of a portable computer 40 according to the present invention. The portable computer 40 comprises a processor 41, a memory 42, a plurality of function buttons 43, an input/output interface 44, a screen 45 and a wireless input/output device 46. The portable computer 40 is similar to a standard computer. In the embodiment, the portable computer 40 uses the wireless input/output device 46 (such as a infrared port or a radio port) to wirelessly transmit data to the connection device 50.

FIG. 5 is a circuit drawing of a connection device 50 according to the present invention. The connection device 50 comprises a processor 51, a memory 52, a wireless input/output device 56, a computer link interface 57 and an operational device link interface 58. The wireless input/output device 56 corresponds to the wireless input/output device 46 of the portable computer 40 so that data may be transmitted between the two wirelessly. The computer link interface 57 is used for connecting to the teaching computer 20. The operational device link interface 58 is used for connecting to the plurality of operational devices 30. A primary function of the connection device 50 is to transmit signals between the teaching computer 20, the operational device 30 and portable computer 40. The connection device 50 is a simple device, is not the point of the present invention, and so will not be elaborated upon.

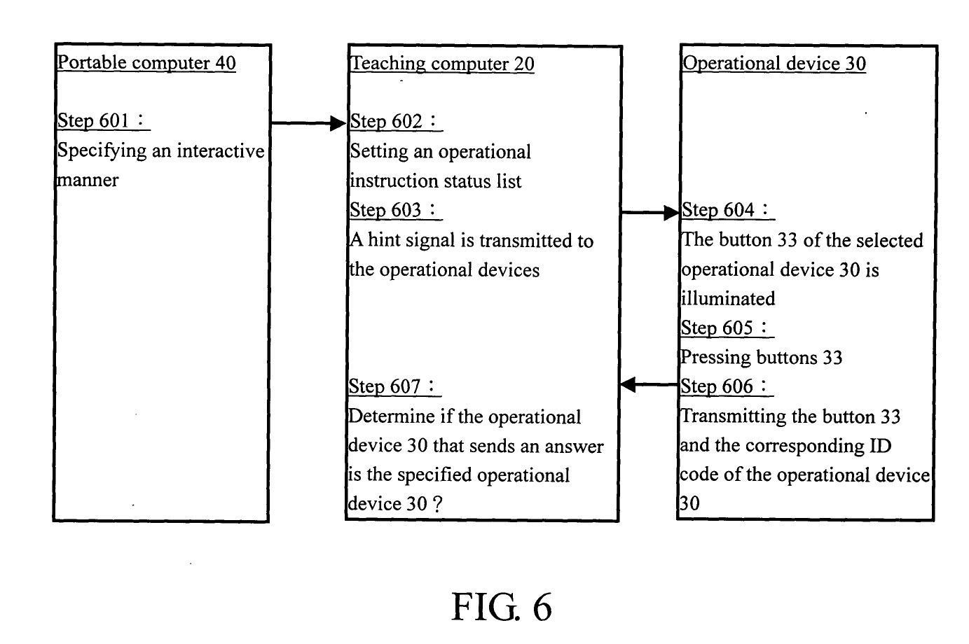

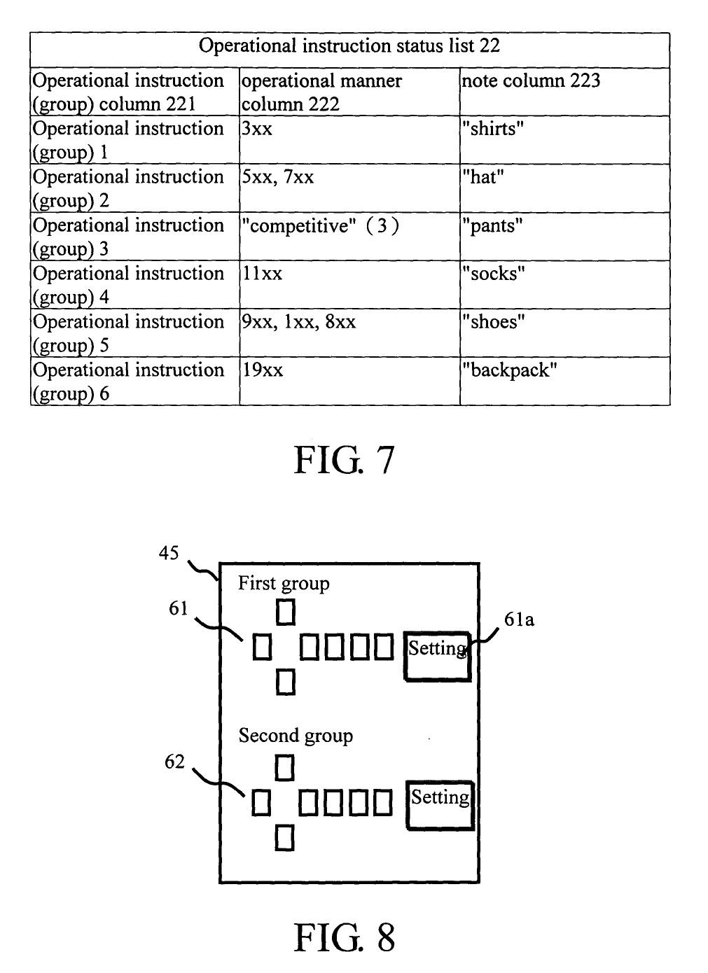

FIG. 6 is a flowchart of an interactive learning system according to the present invention. During the following description of the present invention, please also refer to FIG. 7 to FIG. 9.

Step 601:

The teacher uses the portable computer 40 to specify an interactive manner for the interactive learning program 21 and to send an operational instruction for this interactive manner to the teaching computer 20.

One aspect of the present invention concerns the flexibility and sensitivity of the interactive learning system. An operating example of the interactive learning software 21 is discussed below.

The most common approach of the learning software is “Q&A”, in which a question is presented on the computer screen, and the student can answer “Yes” or “No”, or pick a multiple-choice answer. A typical quiz format (the computer will show the first who answers the question, or compiles statistics for all answers), which is widely adopted in TV shows, can also be successfully used in a teaching environment.

The present invention can help the teacher to control the entire interactive teaching manner, which is in contrast to the prior art TV show method. For example, the teacher can specify that one particular student answer the question; or randomly specify one or more students to answer a question; or accept more than one student to provide answers, such as the first five students.

Furthermore, the teaching software program can be a more complicated game type software program; for example one question could be, “What should you do before you go to school?” The teaching program may then show a picture of a child who has just gotten out of the bed, with shirts, hats, pants, socks, shoes and a backpack as six additional elements within the picture. The student can use the operational device 30 to put these six elements on the child. In general, the prior art teaching software program can be operated in conjunction with an input device (such as a keyboard or a mouse), and the user can put these six elements on the kid by operating the input device. In the present invention, the teacher can specify one student to manipulate these six elements, or assign theses six elements to six different students, or to any other students. For example, the third student may only be permitted to work on the “shirts” element, the fifth student may only work on the “pants” element, the ninth and tenth students may only work on the “backpack” element, etc., so that there can be multiple students utilizing different parts of the teaching software program.

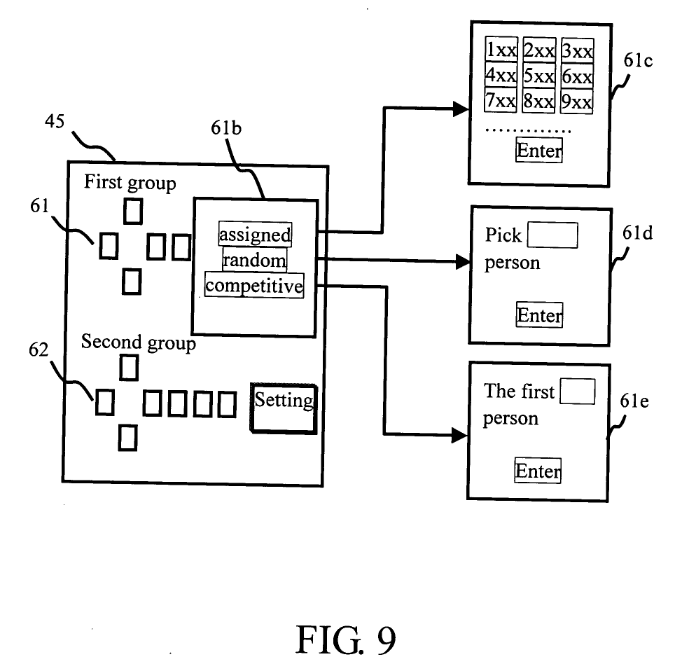

Please refer to FIG. 8 and FIG. 9. FIG. 8 shows an operating screen of the portable computer 40 according to the present invention. FIG. 9 shows another operating screen of the portable computer 40 according to the present invention. In this embodiment, a displaying screen 45 of the portable computer 40 displays a first set of visual buttons 61 and a second set of visual buttons 62. The visual buttons 61, 62 can be designed along the manner used for the buttons 33 of the operational device 30. The displaying screen 45 can show more sets of visual buttons or scroll to a next page to show more sets of visual buttons. In last “What should you do before you go school?” question, the first set of visual buttons 61 can be used for operating the “shirts” element, and the second set of visual buttons 62 can be used for operating the “hat” element, and so on so that the displaying screen 45 of the portable computer 40 will show six sets of the visual buttons (the displaying screen 45 can scroll to the next page if all of the visual buttons cannot be displayed on a single page).

Please refer to FIG. 8. If the teacher wants to set a predetermined limitation on an operation manner for the “shirts” element, the teacher can press a setting button 61a. A setting window 61b will then be shown on the displaying screen 45. As shown in FIG. 9, there are three interactive manner options: “assigned”, “random” and “competitive” displayed in the setting window 61b.

If the teacher selects the “assigned” option, an assigning window 61c will be shown on the displaying screen 45. The assigning window 61c will show a plurality of ID codes for the input/output interfaces 34, or a plurality of student numbers, or a plurality of seat numbers (if the ID codes for the input/output interfaces 34 are set to match the seat numbers, it will be easier on the teacher). The teacher can specify any student (one student or more than one student) to operate the “shirts” element. For example, if the teacher specifies the third student, the third student can uses the operational device 30 to operate the “shirts” element. On the other hand, the teacher can also use the first set of visual buttons 61 to operate the “clothes” element (to assist the students or to provide a demonstration, and so the visual buttons should be designed along the same lines as the buttons 33 of the operational device 30).

If the teacher selects the “random” option, a random window 61d will be shown on the displaying screen 45. The teacher can input a number of people for answering the question, such as two, and the interactive manner control software 49 (or the interactive learning software program 21 of the teaching computer 20) will randomly select two students, such as the twelfth student and the seventeenth student, to operate the “shirts” element.

If the teacher selects the “competitive” option, a competitive window 61e will be shown on the displaying screen 45. The teacher can input the number of people that will be allowed to answer the question, such as allowing only one person to answer the question, so that the interactive learning software program 21 is only used by the first operational device 30 which output operational instructions to the teaching computer 20.

After this setup, the portable computer 40 will send the appropriate control instruction for the interactive program to the teaching computer 20.

Step 602:

An operational instruction status list 22 is set up.

Please refer to FIG. 7. FIG. 7 shows an embodiment of an operational instruction status list 22 according to the present invention. The operational instruction status list 22 has an operational instruction (group) column 221, an operational manner column 222 and a note column 223.

The operational instruction status list 22 is set up according to step 601 described above. The operational manner column 222 records the operational device 30 that is selected from the “assigned”, “random” or “competitive” options in the step 601.

For example, the operational instruction (group) 1 corresponds to an operational manner column 222 which records “3xx”, meaning that the operational device with an ID code “3xx” can use the operational instruction (group) 1 to operate the corresponding element. Taking another situation as an example, the operational instruction (group) 3 corresponds to an operational manner column 222 that records “competitive (3)”, meaning that the first three operational devices 30 that send out the answer can use the operational instruction (group) 1 to operate the corresponding element.

Step 603:

A hint signal is transmitted to the operational devices 30. Please see the next step 604 for further description of this step.

Step 604:

The button 33 of the selected operational device 30 is illuminated. Steps 603 and 604 are not required steps. For example, the displaying picture of the teaching computer 20 can also show a hint signal, or the teacher can provide an oral hint.

Step 605:

The student presses the button 33 to perform an operation.

Step 606:

The signal for the button 33 and the corresponding ID code of the operational device 30 is transmitted to the teaching computer 20. Any signal output by the operational device should have an attached ID code. The plurality of ID codes are stored in the memory 32.

Step 607:

Determine if the operational device 30 that sends an answer is the specified operational device 30.

For example, according to the operational instruction status list 22, the operation of the “shirts” element can only be performed by the operational device 30 which has the “3xx” ID code.

Under the “competitive” option, the teaching computer only accepts the predetermined number of operation instructions sent by the first or the first few operational devices, and ignores the other subsequent operation instructions.

The invention has been described using exemplary preferred embodiments. However, for those skilled in this field the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

Although the present invention has been explained in relation to its preferred embodiment, it is to be understood that many other possible modifications and variations can be made without departing from the spirit and scope of the invention as hereinafter claimed.

What is claimed is:

1. An interactive learning computer system for a teacher and a plurality of students, comprising:
a teaching computer for executing at least one interactive learning software program and outputting graphical information to the teacher and the plurality of students, the interactive learning software being able to accept a plurality of operation instructions;
a plurality of operational devices for use by the plurality of students and outputting operational instructions to the teaching computer to use the interactive learning software program, wherein each operational device has a unique ID code, and the operational instruction is output with one ID code so that the teaching computer is capable of identifying each operational device; and
a portable computer for use by the teacher, the portable computer capable of executing an interactive control software program to output a control instruction to the teaching computer so that the interactive learning software selectively accepts the operating instruction from the operational device.

2. The interactive learning computer system as claimed in claim 1 wherein the teacher can use the interactive control software program to specify controllable operational instructions for each operational device so that the interactive learning software selectively accepts the operating instruction from the operational device.

3. The interactive learning computer system as claimed in claim 1 wherein the teacher can use the interactive control software program to specify one operational device to process the interactive learning software program so that the interactive learning software is only used by the specified operational device.

4. The interactive learning computer system as claimed in claim 1 wherein the teacher can randomly select at least one operational device by using the interactive control software program to process the interactive learning software program so that the interactive learning software program is only used by the selected operational device.

5. The interactive learning computer system as claimed in claim 1 wherein the teacher can select a “competitive” option by using the interactive control software program to process the interactive learning software program so that the interactive learning software program is only used by the by the first or the first few operational devices.

6. The interactive learning computer system as claimed in claim 1 further comprising a connection device so that the output operational instruction from the plurality of operational devices is sent to the teaching computer via the connection device.

7. The interactive learning computer system as claimed in claim 6 wherein the plurality of operational devices are connected to the connection device via cables, and the connection device is also connected to the teaching computer via a cable.

8. The interactive learning computer system as claimed in claim 6 wherein the control instruction output by the portable computer is first sent to the connection device and then to the teaching computer.

9. The interactive learning computer system as claimed in claim 6 wherein the control instruction output by the portable computer is sent to the connection device in a wireless manner.

10. The interactive learning computer system as claimed in claim 1 wherein the teacher can also use the portable computer to output an operational instruction to the teaching computer to use the interactive learning software program.

11. A computer readable medium storing an interactive learning software program, the interactive learning software program being usable by a plurality of students, the plurality of students using different operational devices to output a control instruction to use the interactive learning software program, wherein each operational device has a unique ID code that is output with the control instruction, the computer readable medium storing:
an operational instruction status list for recording the acceptable operational instructions sent by particular ID codes;
program code for changing the operational instruction status list; and
program code for deciding which operational instruction with the ID code should be executed by checking the operational instruction status list.

12. The computer readable medium as claimed in claim 11 wherein the operational instruction status list sorts a plurality of operational instructions into a plurality of operational instruction groups, each operational instruction group comprising at least one operational instructions, and the operational instruction status list records the acceptable operational instructions sent by acceptable ID codes for each operational instruction group.
